(19) United States
(12) Patent Application Publication
(10) Pub. No.: US 2008/0095041 A1
(43) Pub. Date: Apr. 24, 2008

(54) State Restoration in a Communication Network Via Redundant State Storing

(76) Inventor: Joachim Charzinski, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,815

(22) PCT Filed: Aug. 17, 2005
(86) PCT No.: PCT/EP05/54052

§ 371 Date: Feb. 22, 2007

(30) Foreign Application Priority Data
Aug. 24, 2004 (DE) 10 2004 041 012.7

(51) Int. Cl. H04L 12/56

(52) U.S. Cl. 370/216

(57) ABSTRACT

In one aspect, a method for restoration of states maintained in a signalization component of a communication network, after a failure or disruption is provided. An additional signalization component of the communication network is distributed to at least one state in order to protect the states and is stored in said component in the form of a copy. After a failure or disruption of the signalization component, the state stored in the additional signalization components is called up by the signalization component for restoration.

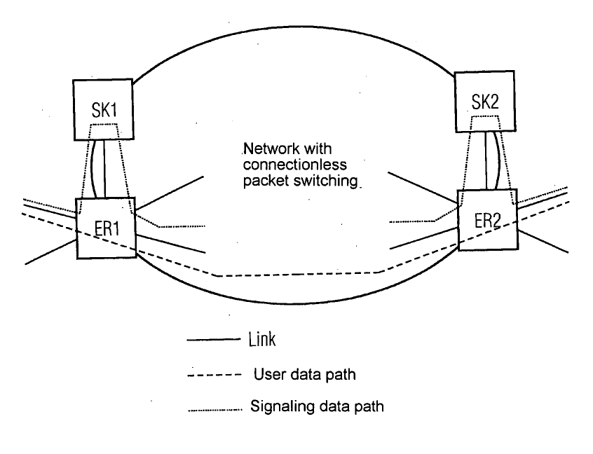

### CROSS REFERENCE TO RELATED APPLICATIONS

This application is the US National Stage of International Application No. PCT/EP2005/054052, filed Aug. 17, 2005 and claims the benefit thereof. The International Application claims the benefits of German application No. 102004041012.7 DE filed Aug. 24, 2004, both of the applications are incorporated by reference herein in their entirety.

### FIELD OF INVENTION

The invention relates to a method for restoring states kept in a signaling component of a communication network and to a device having a signaling component.

### BACKGROUND OF INVENTION

Conventional data networks, which are mostly IP-based (IP: (Internet Protocol), only offer a transmission service exhibiting what is termed “best effort” transmission quality, meaning with no guarantees of transmission quality, and can therefore manage with a minimal signaling overhead. When data is transmitted over the most frequently used data transmission medium, namely the internet, only end-to-end signaling (for example a connection setup by means of the TCP Protocol) as a rule takes place with no reserving of resources (for example bandwidth). A plurality of networks are as a rule involved when data is transmitted over the internet. Signaling within said individual networks is as a rule unnecessary for transmitting data. The individual routers in a network decide autonomously for each packet about forwarding to the next router or, as the case may be, next hop, so that signaling that encompasses the network, for example setting the routers, is not required.

With the efforts underway to make a data network or, as the case may be, packet-oriented networks suitable for realtime transmission services, the requirements have changed: There is now a need to be able to guarantee the transmission quality within individual networks. That is referred to as maintaining Quality-of-Service features or parameters. The traffic requiring to be transmitted must for that purpose be regulated and—if necessary—restricted by means of access controlling. The terms “admission control”, “policing”, “traffic shaping”, and “traffic conditioning” are customary in this context in the relevant technical terminology. For transmitting traffic in a manner adhering to Quality-of-Service parameters, current approaches are aimed at reserving resources or, as the case may be, bandwidth. Reserving of said kind or, as the case may be, the assigning of bandwidth to the traffic requiring to be transmitted requires an exchange of signaling messages within a network so that the individual instances responsible for controlling access or, as the case may be, reserving can be coordinated within the network.

One method, developed as part of what is termed the KING (Key Components of the Mobile Internet of Next Generation) project, for limiting traffic provides in the case of a packet-oriented communication network for access controlling which, for a flow requiring to be transported, relates to the input node and output node via which the traffic that is to be conveyed or, as the case may be, has been announced is to be transported into the network or, as the case may be, out of it again. Access controlling of said type for packet-oriented networks has been described in, for example, the publications W02004021647 and W02004021648.

Reserving for networks having access restriction is as a rule performed with the aid of what are termed signaling components. Said signaling components have to store all active reservations or, as the case may be, settings so that configurations that have been made can be rescinded again on termination of a reservation. If a signaling component fails or becomes faulty, the packets of already allowed reservations will continue being handled by the correctly configured routers in keeping with the specified requirements. When the fault has been cleared or, as the case may be, when the signaling component has been restarted, said component should assume an operating state in which its information about the current settings or, as the case may be, configurations is available so that new reservation requests can be handled adequately and existing reservations properly terminated. Additional hard-disk storages are conventionally provided therefore for backing up the information about the current states.

### SUMMARY OF INVENTION

An object of the invention is to disclose a flexible way to back up the states existing in a network.

Said object is achieved via a method and a device according to the independent claims.

States kept in a signaling component of a communication network are for backup purposes inventively notified to a further signaling component (referred to below also as a “partner signaling component”) and stored there as a copy. After an outage or the occurrence of faults, the state stored in the partner signaling component can then be interrogated by the signaling component in order to be restored. A signaling component is therein understood as being any instance within a communication network that is responsible for signaling processes, for example within the scope of reservations, access controlling, or network-element settings. What is understood as a state is any information that relates to a transmission within or over the communication network and is variable or can be set. A state can relate to, for example, flows currently being transported, available bandwidths, or a setting relating to access controlling.

The invention has the advantage that the network's individual signaling components require no additional backup storage. It is more flexible than conventional backups to additional hard-disk storages inasmuch as backup information can be distributed among any partner signaling components. A partner signaling component in which all the signaling component's states are stored can therein, for example, be specified for a signaling component. However, states are preferably stored in partner signaling components associated with the respective signaling component by way of the state. For example, a state relating to a resource reservation between an input node and an output node can be stored in signaling components assigned to both nodes. States can in this way also be selectively reconstituted.

A development of the inventive subject matter relates to states which, for maintaining the state, require regular confirmation messages or, as the case may be, refresh messages (referred to in the relevant technical literature as soft states). The confirmation messages are according to said development sent to the respective partner signaling component for refreshing a state of said type, as a result of which an undesired termination of said state while a signaling component has failed or is faulty is avoided.

The interrogation for restoring states can be augmented by an interrogation of settings or, as the case may be, configurations of network elements that are associated with the existing states and thus supply information for reconstituting the states.

The inventive subject matter also includes a device having a signaling component in which states of other signaling components can be stored for the purpose of restoration following an outage. Said signaling component can include means for implementing an inventive method.

### BRIEF DESCRIPTION OF THE DRAWINGS

The invention is explained in more detail below using an exemplary embodiment and with the aid of a sole FIGURE. The FIGURE shows a network IPNet having connectionless packet switching, for example an IP network.

### DETAILED DESCRIPTION OF INVENTION

Two edge nodes or, as the case may be, edge routers IR1 and IR2 are shown that function in each case as an ingress node or egress node. Said two edge nodes IR1 and IR2 are assigned to signaling components SK1 and SK2. A state relating to a bandwidth reservation between the two nodes IR1 and IR2 is inventively stored or, as the case may be, kept in both signaling components SK1 and SK2. Following failure of the signaling component SK1 the current states will, after a restart, be interrogated from the partner signaling components SK2.

More generally, each signaling component keeps all states by which it is affected as a network-input signaling component and those by which it is affected as a network-output signaling component. A signaling component that has suffered a brief outage can now, after being restarted and via a protocol used therefore, interrogate all other signaling components for which it has itself respectively assumed the partner role for information about reservations, and in that way re-synchronize its own state tables. Slow, permanent backup of states to hard disk is therein unnecessary.

A suitable method for synchronizing the states after the signaling component SK1 has failed can appear as follows:

For all other signaling components SK_i in the network
SK1→SK_i: GET_BUDGET(1,i); GET_BUDGET(i,1)
SK_i→SK1: BUDGET_INFO(1,i); BUDGET_INFO(i,1)
[SKI can already process new requests again from this point on]
SK1→SK_i: GET_FLOW_LIST(1,i); GET_FLOW_LIST(i,1)
SK_i→SK1: FLOW_LIST_INFO (1,i); FLOW_LIST_INFO(i,1)

The instructions GET_BUDGET(1,i) and GET_BUDGET(i,1) initiate sending of the information relating to the nodes assigned to the signaling components SK1 and SK_i regarding the bandwidth currently available for reservations for transmitting traffic in both directions.

The requested information is sent using BUDGET_INFO(1,i) and BUDGET_INFO(i,1).

The instructions GET_FLOW_LIST(1,i) and GET_FLOW_LIST(i,1) initiate the sending of lists of the flows currently being transmitted in both directions between the nodes assigned to the signaling components SK1 and SK_i.

The requested information is sent using FLOW_LIST_INFO(1,i) and FLOW_LIST_INFO(i,1).

The corresponding transmission of the information should be safeguarded against packet losses, for example by using a transport protocol such as TCP (Transfer Control Protocol) or SCTP (Stream Control Transmission Protocol).

So that the partner signaling components can keep the respective states ready, part of the information must in an expansion of standard signaling be transported additionally. For example, the budget value Budget(1,2) still available after the reservation request has been taken into account, which is to say the bandwidth still available for bandwidth reserving for transmitting from node ER1 to node ER2, can in each case be co-transmitted during internal signaling from the signaling component SK1 to the signaling component SK2. A configuration number for the respective traffic flow could additionally also be co-transmitted, with said number serving simultaneously as an index for the configuration of router tables.

1.-8. (canceled)

9. A method for restoring states kept in a first signaling component of a communication network, comprising:
sending a state is to a second signaling component of the communication network where a copy is stored; and
interrogating the second signaling component for the stored copy of the state for the purpose of restoring the first signaling component.

10. The method as claimed in claim 9, wherein the state relates to a reserving of a resource, an access control, or a parameter setting.

11. The method as claimed in claim 9, wherein the first signaling component is provided by a network-access control unit, a resource-reserving agent, or a bandwidth-setting unit.

12. The method as claimed in claim 9, wherein the state comprises information relating to a transmission between a first node assigned to the first signaling component and a second node assigned to the second node.

13. The method as claimed in claim 9, further comprising:
maintaining the state in the first signaling component via a message; and
sending the message to the second signaling component.

14. The method as claimed in claim 9, wherein the interrogation is augmented by an interrogation of settings of network elements.

15. A device having a second signaling component, comprising:
a storage for storing a state of a first signaling component; and
an interrogation mechanism to provide the stored state to the first signaling component for restoring the state in the first signaling component in response to a fault in the first signaling component.

16. The device as claimed in claim 15, wherein the state relates to a reserving of a resource, an access control, or a parameter setting.

17. The device as claimed in claim 15, wherein the first signaling component is provided by a network-access control unit, a resource-reserving agent, or a bandwidth-setting unit.

18. The device as claimed in claim 15, wherein the state comprises information relating to a transmission between a first node assigned to the first signaling component and a second node assigned to the second node.

19. The device as claimed in claim 15, wherein a message for maintaining the state in the first signaling component via a message is received by the second component to maintain the state in the second component.

20. The device as claimed in claim 15, wherein the interrogation is augmented by an interrogation of settings of network elements.
